(19) United States
(12) Patent Application Publication
(10) Pub. No.: US 2012/0221474 A1
(43) Pub. Date: Aug. 30, 2012

(54) Secure Electronic Ticketing using Mobile Communication Devices over the Internet

(75) Inventors: Richard Barry Eicher, Windham, NH (US); Richard Barry Eicher, JR., Windham, MA (US)

(73) Assignee: SKYCORE LLC, Boston, MA (US)

(21) Appl. No.: 13/033,910

(22) Filed: Feb. 24, 2011

(51) Int. Cl. G06Q 30/00; H04L 9/00; G06F 17/00

(52) U.S. Cl. 705/51; 235/375; 705/26.1

(57) ABSTRACT

The invention consists of a method and system for secure mobile ticketing through the use of a mobile device with display output and data input capabilities. The system utilizes a cryptographic security string appended to a URL and embedded in a 2D barcode to securely create an electronic ticket which is displayed on the mobile device display for redemption, redeem the displayed electronic ticket by means of optical scanning, and optionally register and authenticate a ticket scanning unit. The system utilizes real-time internet communication with a remote server for ticket distribution, redemption and ticket scanning unit registration and authentication to restrict unauthorized creation or redemption of electronic tickets and to reduce queuing.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The mobile ticketing industry is a relatively recent and up-and-coming portion of the fast-growing e-commerce industry. According to some estimates, over 400 million mobile subscribers worldwide will use their mobile phones for ticketing by 2013, with total gross mobile ticketing transactions reaching $92 billion by 2013.

The concept that customers can order, pay for, obtain and redeem tickets at their convenience from nearly any location, at any time using mobile devices is the foundation of mobile ticketing industry. In addition to convenience, mobile tickets provide the added benefit of reducing or eliminating some of the production, distribution and redemption costs associated with traditional paper-based ticketing systems. Furthermore, mobile ticketing reduces the customer's fear of losing a physical ticket, and allows vendors to significantly reduce ticket queues. The recent adoption of mobile ticketing by airlines, transit authorities and event ticket vendors is an indication of potential for dramatic growth in the use of mobile devices for ticket purchase and redemption.

Some issues that have arisen in the adoption of mobile ticketing include bar code reading issues, lack of reader infrastructure and the availability of NFC (Near Field Communications) handsets. Mobile tickets are intended to be less susceptible to fraud or illegal resale, though many potential deterrents, such as name and photo identification checks, are not currently feasible in all ticket redemption environments.

As more consumers and merchants recognize and exploit the increasing availability of broadband cellular networks and Wi-Fi hotspots, and the growing proliferation of sophisticated mobile devices with increased computer power and improved features and capabilities, it is no surprise that the ticketing industry now seeks to utilize mobile devices to both receive and redeem mobile tickets. However, though these advances in telecommunications have lowered the start-up costs of establishing mobile ticketing systems, they have also presented significant security challenges for mobile ticket vendors. If unauthorized mobile devices are able to redeem mobile tickets, the value of the mobile ticketing industry is severely diminished by lack of consumer confidence in the security of mobile tickets purchased.

Until recently, data transfer rates for mobile internet access, as available to consumers, have been insufficient for real-time transactions. Consequently, local systems were essential to digital ticketing systems. Innovation in real-time web access has enabled consumers and merchants to receive information over public IP and wireless networks at nearly the instant it is published, instead of requiring that they or their software check a remote source periodically for updated information. This real-time information delivery is one of the most important elements for the adaptability of the web for applications like mobile ticketing.

Moreover, the average person did not possess the ability to decode a barcode with a mobile device until recently. Presently, many mobile devices with built in image acquisition hardware contain universal barcode scanning applications which transform the mobile device into a fully functional barcode scanner. These barcode scanners are capable of reading standard barcode types from both paper and mobile mediums. It is precisely this versatility and enterprise connectivity that make mobile devices a potential risk for mobile ticketing enterprises. To provide the level of security that the industry requires, mobile device security solutions should be integrated with mobile tickets, centrally managed, and capable of wireless deployment, updating and compliance.

Accordingly, there is a current need for a method of enabling mobile ticket transactions to be facilitated and fulfilled in a prompt and convenient manner without compromising security. The system and methods of the present invention disclosed herein address this need.

### BRIEF SUMMARY OF THE INVENTION

The present invention offers a system and a series of methods to improve the security and promptness of the creation and redemption of mobile tickets over Internet Protocol (IP) networks. Such system embodies a method for generating an electronic ticket represented as a unique Uniform Resource Locator (URL); a method by which said URL is encoded into a 2D barcode object and sent to the user's device by Multimedia Message Service (MMS) or through Wireless Application Protocol 2.0 (WAP)/Short Message Service (SMS); a method by which a ticket scanning unit is authenticated; and a method disclosing a process by which the mobile ticket is swiftly and securely redeemed using the authenticated ticket scanning unit.

One embodiment of the present invention is a method for creation of an electronic ticket. The method includes the step of cryptographically formulating a mobile ticket security string and an identification string for a legitimate ticket which may only be known and authenticated by the mobile ticket provider. The method further includes the step of combining the identification string and mobile ticket security string and appending said combination to a designated URL. By formulating a unique ticket identification number and an encrypted mobile ticket security string, it is extremely difficult for anyone other than the mobile ticket provider to create valid digital tickets. This method moreover includes the step of embedding the URL into a 2D barcode object, for example, a Quick Response (QR®) code. Thus, this system allows tickets to be securely created, and provides a security measure against unauthorized creation, reproduction and redemption of electronic tickets.

Another embodiment of the present invention is a method of authenticating a ticket scanning unit. The method includes the step of registering the ticket scanning unit with the mobile ticketing provider prior to an event, so that it may be recognized during mobile ticket redemption, by either manually entering the identification number of the unit or alternatively automatically cataloguing and registering the unit by scanning a certification barcode object. The method moreover includes the step of linking the scanning unit to a single event or multiple events, which allows scanning units to be securely administered and linked to events, preventing unauthorized redemption of electronic tickets by non-registered devices.

One embodiment of the present invention is a method for electronic ticket recognition and decoding. This method includes the step of the mobile ticket consumer displaying the ticket on their portable device to the event administrator to confirm its validity and be granted entry to the event. The method further includes the ticket scanning unit deciphering the mobile ticket barcode object into a URL and appending its device identification string to the URL. The mobile ticket, which consists of an encrypted barcode, reduces fraud by ensuring that only a valid ticket holder may retrieve the ordered goods or services. While unauthorized duplication of a legitimate digital ticket may be possible, only the first-presented copy of the digital ticket can be redeemed. Although replication of mobile tickets may be recognized as detrimental to mobile ticket consumers, the ability to transmit tickets between individuals with limited restrictions can be beneficial. Mobile ticket consumers wishing to distribute their purchased mobile tickets to friends or family can do so with ease.

Another embodiment of the present invention is a method of verifying and redeeming a mobile ticket. The method includes the step of accessing the host server of the mobile ticket's URL through a data call. This method further includes the step of accessing the mobile ticket through the use of HTML “GET” techniques, without initiating a browser session outside of the scanning application. The response from the HTTP “GET” will be parsed and displayed directly within the scanner application. Accessing ticket information by opening up a new browser session is too inefficient for real time redemption applications. In existing common ticket redemption applications the scanner unit is accustomed to procuring ticket information from the portable memory media storage of the ticket scanning unit. Since the invention is to be utilized with a broad range of multi-purpose mobile devices, rather than exclusively specialized scanning units, storage of ticket information on the device itself may not be desirable. This method moreover may include the step of responding to the ticket scanning unit and/or the user with a customized response message based on the success or failure of the ticket redemption process and the particular mobile ticket application.

By virtue of the unique combination of elements that make up the present invention, it may be found that the distribution and redemption process for each mobile ticket shall be much more expedient and secure than with such conventional mobile ticketing systems.

### BRIEF DESCRIPTION OF THE SEVERAL VIEWS OF THE DRAWING

FIG. 1 illustrates a portable or mobile computing device that displays an electronic ticket;

FIG. 2 is a flow chart illustrating the steps taken in using an electronic ticket for entry at a ticketed event;

FIG. 3 is a diagram showing example implementations for a user interacting with a commercial account via a portable or mobile computing device in connection with the system of the present invention;

FIGS. 4 and 5 are flow diagrams showing process steps involved in example implementations of facilitating a purchase of an electronic ticket in accordance with the system of the present invention;

FIG. 6 is a block diagram showing information flow of processing electronic tickets in accordance with one embodiment of the present invention;

FIG. 7 is a flow chart illustrating a system for encoding and dispatching mobile-device based tickets using an encrypted mobile ticket security string embedded in a URL;

FIG. 8 is a flow chart illustrating the steps taken for delivery of an electronic ticket to a portable or mobile computing device;

FIG. 9 is a flow chart illustrating the steps taken for electronic ticket recognition and acceptance;

FIG. 10 is a block diagram showing information flow of mobile ticket scanner registration in accordance with one embodiment of the present invention;

FIG. 11A is a block diagram of the system for automatically registering a ticket scanning unit;

FIG. 11B is a block diagram of the system for manually registering a ticket scanning unit;

FIG. 12 is a flow chart illustrating a system for decoding and verifying mobile-based tickets in accordance with one embodiment of the present invention;

FIG. 13 is a block diagram showing information flow of ticketing event entry in accordance with one embodiment of the present invention.

### DETAILED DESCRIPTION OF THE INVENTION

For purposes of promoting an understanding of the principles of the invention, reference will now be made to the exemplary embodiments illustrated in the drawings, and explicit language will be used to detail the same. It will nevertheless be understood that no limitation of the scope of the invention is thereby intended. Any alterations and further modifications of the inventive features manifested herein, and any additional applications of the principles of the invention as depicted herein, which would occur to one skilled in the relevant art are to be considered within the breadth of the invention.

The disclosures herein relate generally to mobile electronic commerce, and more particularly to a specific method and system for prompt and secure facilitation of mobile ticketing.

The invention takes advantage of the availability of mobile computing devices by enabling them to communicate with the various specialized optical scanning devices already widely available, in addition to using mobile computing devices which contain barcode reading applications. This system takes advantage of existing infrastructure widely installed in many venues and/or decreases the expenses associated with creating such a ticketing system.

While the descriptions of the appended figures will portray the preferred manifestation of this invention as being employed with QR® barcodes, it shall be implied that this has been provided by way of example and not as a limitation to the scope or spirit of the invention. The invention may be utilized through one-dimensional and two-dimensional barcodes, images or other objects representing data capable of being read by another device. Moreover, it will be understood that the client device is not limited to mobile telecommunication devices and that the invention is described as being useful in, but not limited to, ticketing applications.

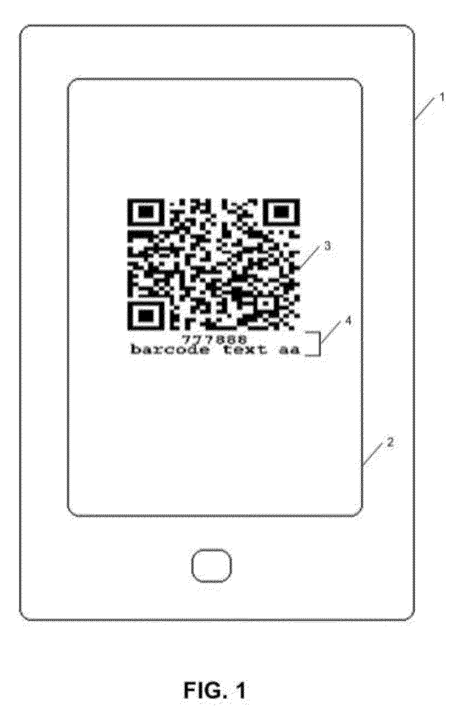

FIG. 1 illustrates a mobile device 1 that displays a 2D barcode 3 for a ticket 4. The major advantage of using a barcode displayed on the screen 2 of the portable device is that the ticket does not have to be printed. Those skilled in field have heretofore operated under the assumption that a physically tangible paper ticket must be present to grant entry.

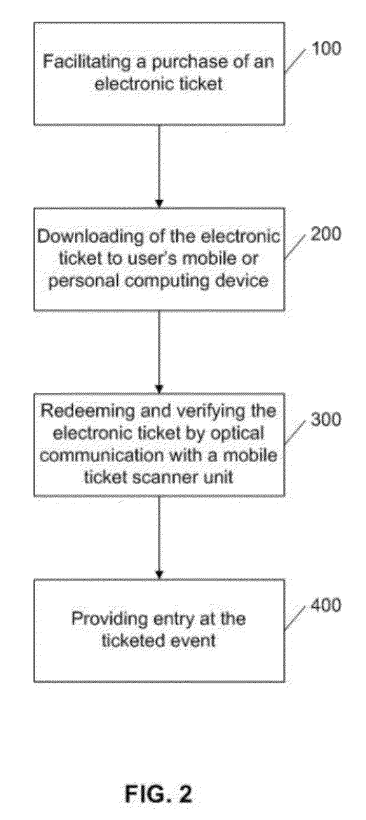

FIG. 2 discloses the process of the purchase, encryption, delivery, and redemption of a mobile ticket. One step of this embodiment is facilitating the purchase of an electronic ticket from a mobile device or networked computing device 100, followed by downloading the electronic ticket through MMS, WAP/SMS, and/or electronic mail delivery methods to the user's mobile or personal computing device with a display output 200. Next, the electronic ticket is verified and redeemed by optical communication with a ticket scanning unit 300, followed by the step of providing entry to the event, and/or delivering the appropriate amenities to a ticket user according to the accepted event, and/or delivering a customizable message 400.

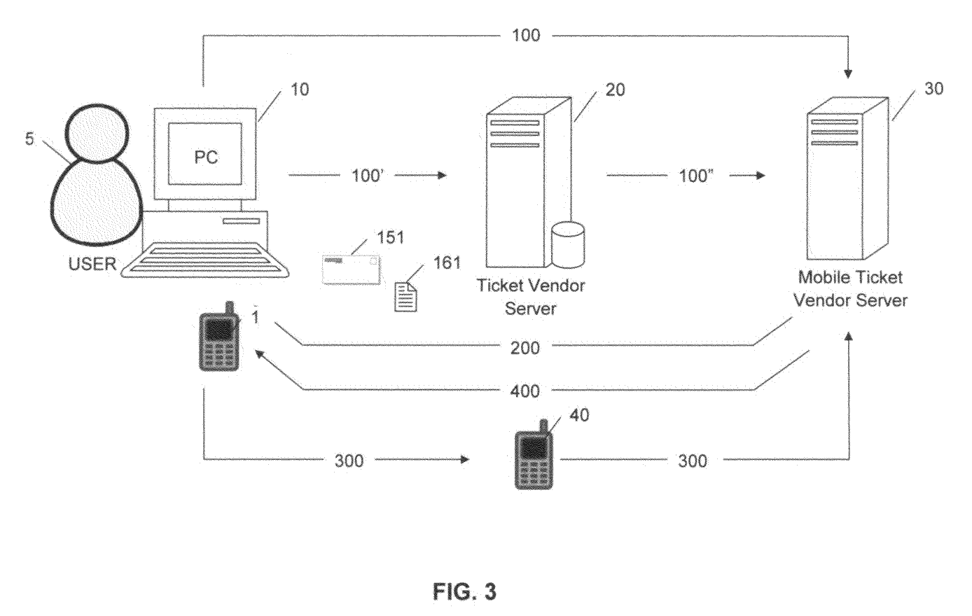

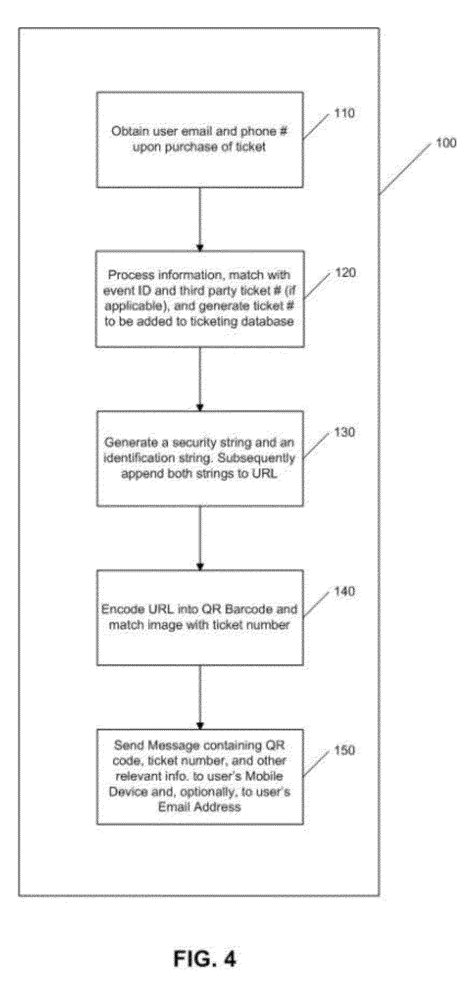

In this embodiment, as shown in FIG. 3, the user 5 can purchase a mobile ticket through with a mobile device 1 or a personal computing device 10 directly from a mobile ticket vendor 100 or indirectly in a two-step process from a ticket vendor 100′ who then obtains the mobile ticket from a mobile ticket vendor 100″. A variety of techniques may be used to permit the user to purchase a mobile ticket—two illustrative techniques are shown in FIGS. 4 and 5. Subsequently, the mobile ticket is delivered from the mobile ticket server 30 to the user 5 through data transmission 200 utilizing email 151 and/or through a MMS or WAP/SMS message 161 to the user's 5 personal computer 10 and/or mobile device 1.

Once the user has received a ticket, the next step is redemption and verification of the mobile ticket 300 through communication between the user's mobile device 1, a ticket scanning unit 40, and the mobile ticket vending server 30. Entry is provided to the ticket event 400, through delivery of a follow-up message to the mobile device 1, ticket scanning unit 40, mobile ticket vendor server 30 and/or 3rd party ticket vendor server 20, depending upon the configuration. The follow-up message to the user's device, like the delivery of the mobile ticket 200, can take the form of an email message 151 and/or MMS or WAP/SMS message 161. The specific nature of these embodiments will be disclosed in substantial detail in the figures described below.

FIG. 4 is a process flow diagram indicating the steps for consummating a transaction in one embodiment of the present invention. This diagram further details the process involved in which a user purchases a mobile ticket directly from a first-party mobile ticketing vendor through flow 100. The method includes the step 110 of the user purchasing a ticket for a particular event, upon which the mobile ticket vendor obtains the user email, phone number, and other personal information essential to the transaction. Another step 120 is the processing of that customer information by the mobile ticketing server, and the matching of this information with the event ID and ticket number stored in a database. The ticket number can be received from the third-party ticket vendor and employed to generate another unique ticket number or, alternatively, if the user is communicating directly with the mobile ticketing vendor, the ticket number may be randomly generated at the outset of the transaction. The uniqueness of ticket numbers generated by the mobile ticketing server is essential for the purpose of preventing duplicate ticket numbers.

A subsequent step is the generation of a mobile ticket security string and an identification string that can only be known and authenticated by the mobile ticket provider 130. The mobile ticket security string is created by encrypting a unique ticket identification string, event identification string, user phone number, user email address, or any combination thereof, or any identification string which is known only to the ticket creator, in a pre-determined or randomized order. The mobile ticket security string may be encoded by the previously discussed entities using encryption algorithms including, but not limited to, DES, AES, and MD5. For the purpose of ensuring authenticity, the mobile ticket security string is not stored in the mobile ticketing database so that it is not possible to penetrate the security of the mobile ticketing database and recreate the electronic ticket. A mobile ticket absent the mobile ticket security string, or without knowledge of the security string, the encryption algorithm and the order in which elements were encoded, is not redeemable.

The identification string consists of, but is not limited to, the ticket number, event number, phone identification number or any combination thereof. In the same step, the encrypted mobile ticket security string and the identification string are appended to a URL. This URL can direct the user to the mobile ticket vendors server, a 3rd party ticket vendor's server, or an alternative hosting server. Said URL is then encoded into a 2D barcode, such as a QR® code, and the barcode image is matched with a ticket number 140. The two-dimensional bar-code is an appropriate encoding technology for the purposes of digital tickets as it provides good fault-tolerance and easy re-digitization of data. Yet another step 150 is sending an MMS or SMS/WAP message to the user containing a 2D barcode, ticket number, and other relevant information to the purchaser's mobile device. A further element of step 150, one which is optional, is the delivery of a notification message to the purchaser's email which includes an attached JPEG file containing the QR® code image and ticket information, similar to that which was sent to the purchaser's mobile device.

FIG. 5 is a process flow diagram illustrating an alternative method for consummating a transaction in one embodiment of the present invention, namely the process invoked when a user purchases a mobile ticket indirectly, in a two-step process, from a third party ticketing vendor (through flow 100′) who then obtains a mobile ticket from a mobile ticketing vendor (in flow 100″.) The method includes 101 the user purchasing a ticket for a particular event from a third-party ticketing vendor, upon which the ticket vendor obtains the user email, phone number, and various personal information necessary to complete the transaction, followed 102 the ticketing server processing the customer information and matching said information with the event ID and ticket number stored in a database.

The next step is the delivery of the ticket number, event identification number, and necessary user information to the mobile ticket vendor 103. This step is followed by the transmission and receipt of information from the third-party ticket vending server 20 to the mobile ticketing vendor server 30 through an information network 104.

Consequent to successful transmission of customer and event information 103 across the information network 104, the mobile ticket vending server 30 receives a third-party event identification number, third-party ticket number, user information, and transaction type in block 110′. The information received from block 110′ is processed and the ticket identification number and ticket number are created in block 120′. Unique ticket numbers are generated by the mobile ticketing server primarily for the purpose of preventing duplicate ticket numbers. In the next step 130 a mobile ticket security string and an identification string of any length, that can only be known and authenticated by the mobile ticket provider, are created. The mobile ticket security string is created by encrypting a unique ticket identification string, event identification string, select user information; or any identification string which may be known to the ticket creator; in a pre-determined or randomized order. The mobile ticket security string may be encoded by the previously discussed entities using encryption algorithms including, but not limited to, DES, AES, and MD5. As previously disclosed in the description of FIG. 4, for the purpose of ensuring authenticity, the mobile ticket security string is not stored in the mobile ticketing database where it would be vulnerable in the case of unauthorized database intrusion. The identification string consists of, but is not limited to, the ticket number, event number, phone identification number or any combination thereof. In the same step, the encrypted mobile ticket security string and the identification string are appended to a said URL.

The URL is encoded into a 2D barcode 140, such as a QR® code, and matched with a ticket number 140, followed by the transmission of an MMS or SMS/WAP message 150 containing the 2D barcode, first- or third-party ticket number as appropriate, and other relevant information to the purchaser's mobile device. An optional element of step 150 is the delivery of a notification message to the purchaser's email. Such an electronic notice contains an attached JPEG file containing the QR® code image and ticket information, like that which has been sent to the purchaser's mobile device.

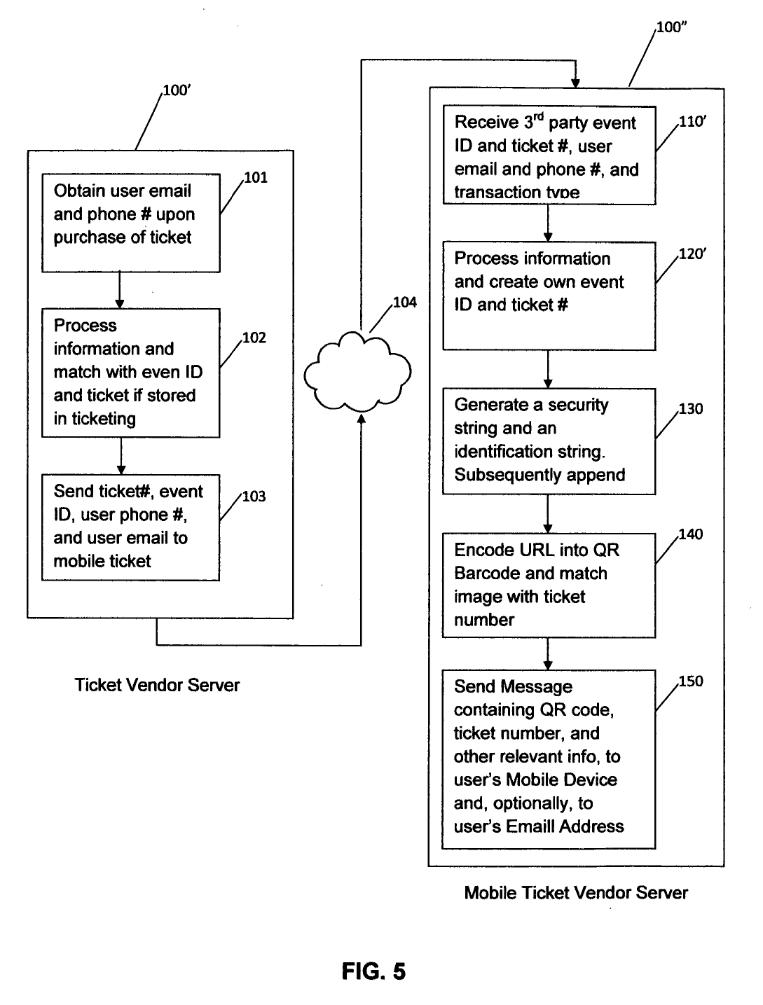

FIG. 6 is a flow chart illustrating an exemplary process for updating a mobile ticketing database 31 upon receiving a request for a ticket. In one embodiment, the method described in FIG. 6 is performed by a mobile ticketing database 31. However, any other module may perform these features.

In a decision block 121, the mobile ticketing database 31 determines if new transaction data has been received. In one embodiment, transaction data may be received directly from the user's mobile device or networked computing device, and, in another embodiment, transaction data may be appropriated from a third party ticket vendor. The transaction data may include information regarding a user, such as address; phone number; email address; maximum transaction allowance; information regarding the requested transaction, such as an event type, date, time, capacity, or quantity of tickets; and/or information regarding the user's authorization to complete the transaction.

From block 121, if it is determined that new transaction data had not been received, the method returns to block 121 and repeats the process. If it is affirmed in block 121 that new transaction data has been received, the method moves to a block 122 wherein the received transaction data is examined to determine if the ticket capacity for the specified event has been exceeded.

If the ticket capacity for the event has been reached, new transaction data is rejected and the user and/or third-party ticket vendor is notified as such. Alternatively, if it is determined that the ticket capacity has not been exceeded, the date and time of the event is verified against the date and time for which the user is currently seeking to purchase a ticket 123. If it is deemed that the date and time of purchase is within the appropriate range for the event for which the user seeks to purchase a ticket, the method moves to a block 124 where the received transaction data is stored in the mobile ticketing database 31. The mobile ticketing database 31 may use any available organization method and file system structure for storage of data.

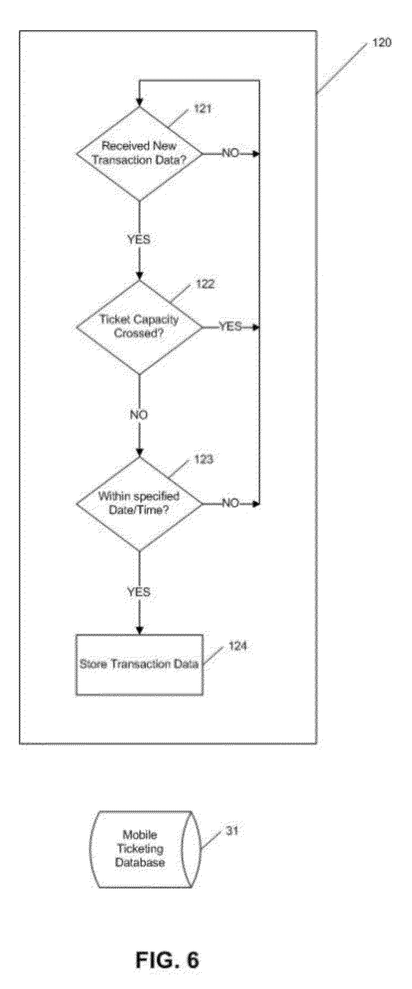

FIG. 7 shows an example of a process involving the creation of a mobile ticket. As illustrated in this figure, a software algorithm stores a customer's information in the mobile ticketing database, encodes a serial number, or other numeric data, alphanumeric data or code into an alphanumeric string which is subsequently appended to a URL, encoded into a QR® code which is sent to a mobile phone using industry-standard communication protocols. In the first step of this example, a system stores relevant customer and ticket information including, but not limited to, event identification, ticket identification, customer name, customer, phone number, and customer email 124 to the mobile ticketing database 31. In another step the ticket identification number, event identification number, phone number of the purchaser, or any combination thereof is randomized and encrypted into a mobile ticket security string 131. The mobile ticket security string can be of any length, so long as it does not exceed the maximum URL length permitted by the web browser used, since the string is to be appended to a URL.

In an additional step, an identification string is generated 132, consisting of, but not limited to, the ticket number, event number, phone identification number or any combination thereof. In a further step, the mobile ticket security string and identification string are converted into a valid URL format and appended to the mobile ticket distribution server's designated host URL 133. Here, the mobile ticket security string and identification string are transposed into a valid ASCII configuration which is safe for transmission across the internet. Yet another step in this embodiment is the encryption of the URL into a QR® code 141. This step is performed by utilizing either customized or commercially available QR® code conversion software algorithms.

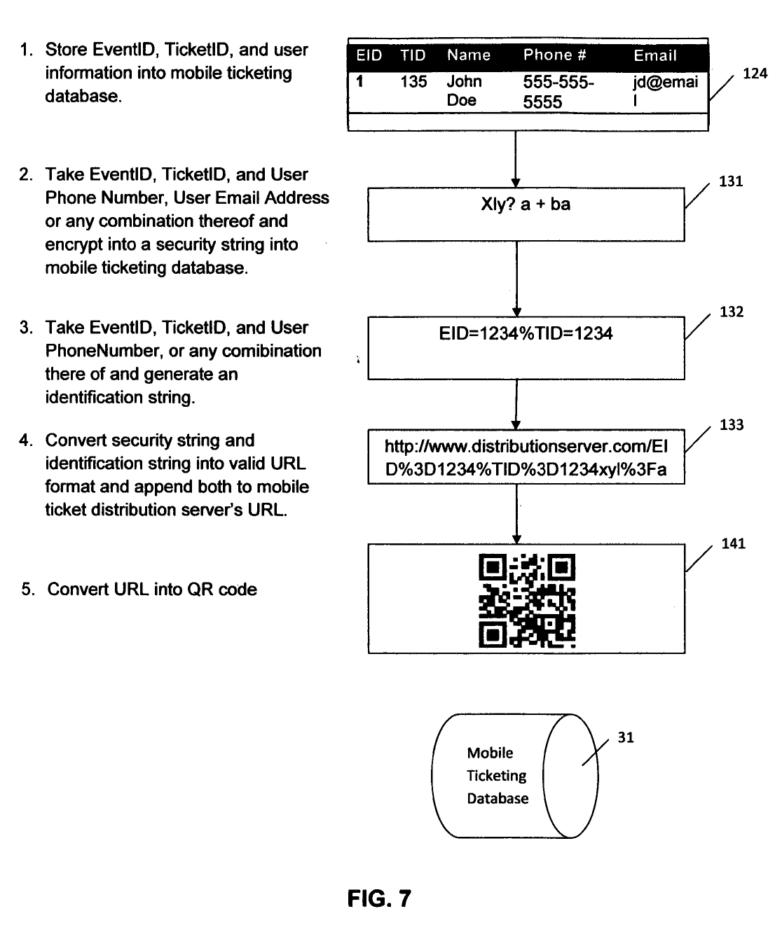

FIG. 8 is a block diagram illustrating three possible, but not exclusive, ways in which the mobile ticket may be delivered to a user. As mentioned previously, the purchased mobile ticket is delivered to the user's mobile device and, optionally, email address. In decision block 210, the mobile ticketing vendor server determines which method of mobile ticket delivery to use. The delivery method chosen is based on an array of variables including, but not limited to, mobile service provider and user preference.

If it is determined in block 210 that the method by which the mobile ticket is to be delivered is through an SMS containing a URL hyperlink, the method moves to block 220, wherein the mobile device receives an SMS in HTML format through use of WAP-Push. On receiving a WAP-Push, the mobile device will automatically give the user the option to access the WAP content. In this way the WAP-Push directs the end user to a WAP address where particular content is stored ready for viewing or downloading to the mobile device. A major benefit of WAP-Push is the ability to send data to a mobile subscriber without an explicit ad hoc request by the end user; unlike an internet URL where the user must request or “pull” content. The use of such a method speeds up the process of accessing a mobile ticket for the end user. From block 220, the user downloads the ticket image (block 230.) To access the mobile ticket the user simply has open the SMS message and access the URL.

Alternatively, if it is determined in block 210 that the method by which the mobile ticket is to be delivered is through MMS, the method moves to block 220′ where the mobile device receives an MMS message. From block 220′, upon successful receipt of the MMS notification, the method continues to block 240′ where the MMS message containing the mobile ticket is then stored as a .JPEG image in the Inbox of the mobile device or in the mobile device's image directory.

Moreover, if it is determined in block 210 that in addition to delivering the mobile ticket via MMS or SMS/WAP-Push, the mobile ticket will be distributed via email, the method moves to a block 220″ where the user receives email notification at the provided email address. The email notification contains event and ticket information, a 2D barcode image, and a link to the encrypted URL of the barcode image. From block 220″, the user downloads the ticket image in a block 230′. The image can either be saved to the portable memory media storage inside their mobile device or personal computing device, or alternatively may be printed onto a paper medium 240″. It is to be noted that the possible methods of mobile ticket distribution disclosed above, are just three of numerous alternative modes of delivering a mobile ticket as a URL.

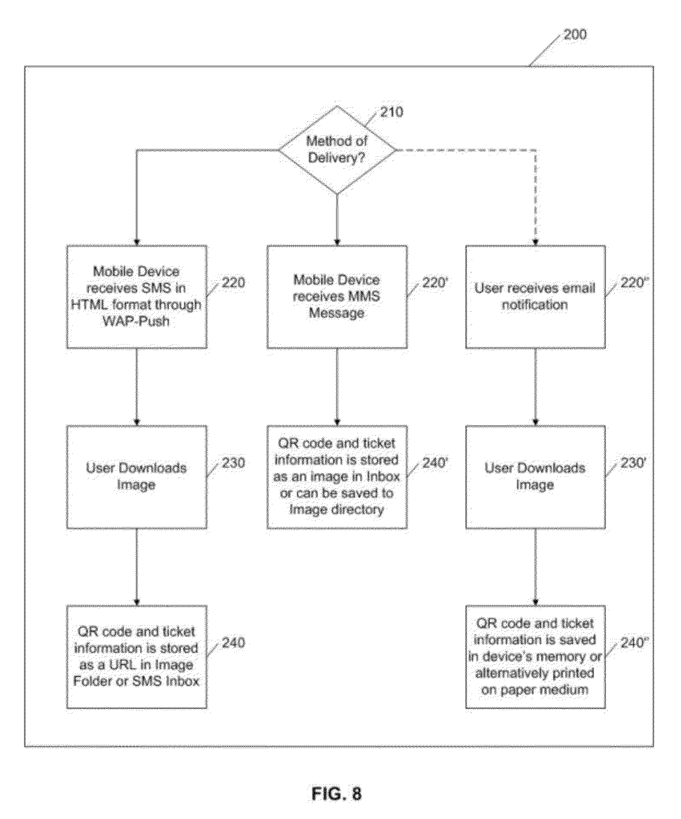

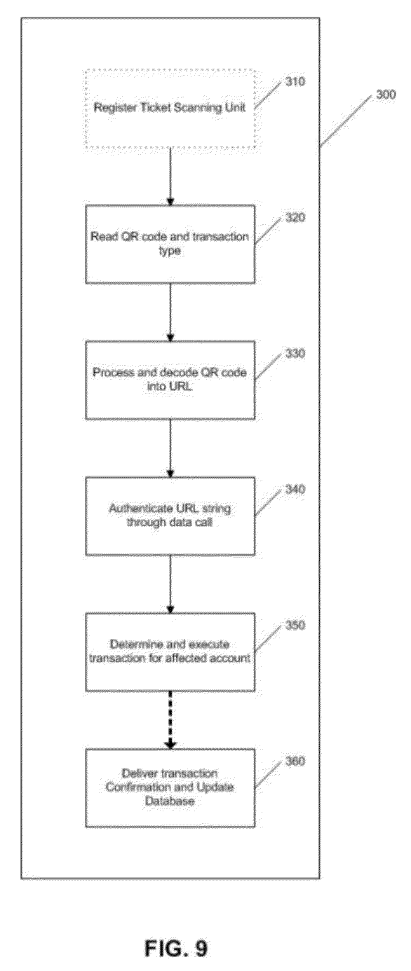

FIG. 9 is a process flow diagram illustrating an exemplary process of securely redeeming a mobile ticket 300 using a ticket scanning unit. As at 310, the ticket scanner is given the option of registering their scanning unit. Registration of the scanning unit is an elective component of the mobile ticketing invention herein disclosed, however such system provides a valuable feature to ticket vendors as well as an additional security measure to consumers fulfilling a transaction. More detailed disclosures pertaining to this embodiment are spelled out in FIG. 10. In block 320 the ticket scanning unit begins the ticket redemption process by optically scanning the users mobile device data output display. It is notable that the scanning unit herein discussed can be either a mobile device containing QR® code decryption software or a commercially available scanning device with QR® decryption capability.

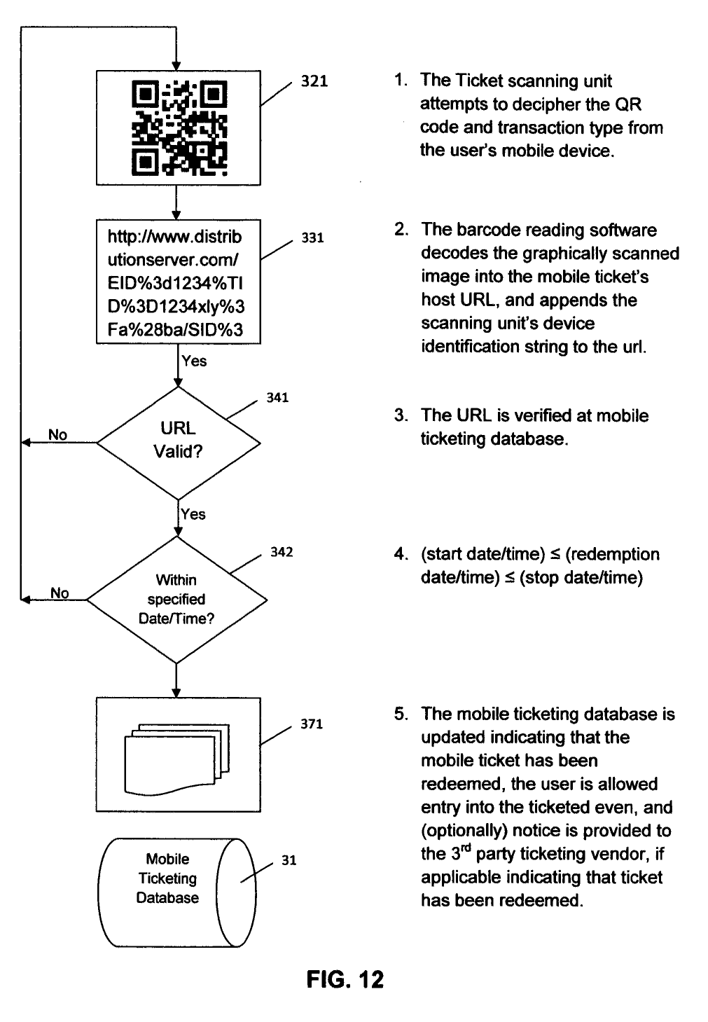

Once the scanner has successfully deciphered the QR® code, identification information and/or transaction information in block 320, the system can process the mobile ticket and any coded information so as to begin the transaction, as at 330 in FIG. 9. In block 330, the QR® code is decoded into the URL, as illustrated in FIG. 12, block 331. Additionally, in a block 330, the scanning unit's device identification string is appended to the URL. The scanning unit's device identification string, for example, may consist of the device's Unique Device Identifier (UDID) or International Mobile Equipment Identity (IMEI) number, in addition to an event ID and an account ID.

In a block 340, the transaction request is either confirmed or denied. The ticket scanning unit accesses the URL string through a data call using the HTTP “GET” method in order to certify the validity of the mobile ticket. Use of a data call permits the URL to be verified without opening up a new browser each time a mobile ticket is redeemed. In the present invention, the unique data call process herein disclosed speeds up the procedure of accessing a URL, thereby making the redemption of a mobile ticket more efficient, and effectively limiting queue times. While the foregoing description of a block 340 portrays the preferred demeanor of accessing the host server of the mobile ticket's URL as being employed through a data call, it shall be understood that the invention will sufficiently, but not optimally, operate through use of former techniques.

Further, in a block 340, the step of authenticating the URL string comprises of verifying the ticket information string and the appended device identification string of the ticket scanning unit. Moreover, in this block, the mobile ticket security string is recreated using data from the ticket information string and data only known by the ticketing provider. The re-encrypted mobile ticket security string is then correlated to the mobile ticket security string contained in the URL. Next, in a block 350, the system determines what account will be affected by the mobile ticket redemption and executes the transaction. In this step, the system can manipulate the information as necessary depending upon whether the user so chooses to receive amenities.

Finally, at an optional block 360, the system determines the appropriate confirmation form and subsequently delivers the assent to the user. Hereby the transaction confirmation information is sent to the user, the scanner, the mobile ticket vendor, and/or the 3rd party ticket vendor, if applicable. The mobile ticketing database is updated with the results from the mobile ticket authorization source. In one embodiment, the mobile ticketing database maintains records of transactions that are currently in process and those that have already been completed. The mobile ticketing database may store the transaction data, including the mobile ticket information, for example, or alternatively store a mobile ticket identifier, along with an indicator of whether the mobile ticket has been redeemed.

FIG. 10 is a flow chart illustrating the exemplary process of registering a ticket scanning unit. This process is an optional feature in the mobile ticketing process herein disclosed in this invention, but is one which is recommended, as it furthers the goal of facilitating a secure transaction. In one embodiment, the method described in FIG. 10 is performed at the mobile ticketing database using input from the scanning device. However, any other module may perform these features. In decision block 311, the mobile ticketing database determines whether a new scanner registration request has been received. From block 311, if it is determined that new scanner registration request has not been received, the method returns to a decision block 311, wherein the mobile ticketing database determines if a registration request has been received from a ticket scanner or venue management personnel.

If it is determined in block 311 that new scanner registration request has been received, the method moves to a block 312 where the ticket scanner or mobile ticketing administrator enters relevant scanner information into the database. The scanner data may include, but is not limited to: scanner name, scanner description, and the date and time upon which scanning are allowed. This feature is described as being useful in applications involving the tracking of scanning units and/or identifying the locale of a scanning unit. For example, the scanner at the front right door of a venue could be given a name such as “front right door scanner”. Furthermore, using this name and the tracking capabilities associated with this embodiment, a ticketing venue could track the number of tickets which were scanned and the success rate of ticket redemption on a per unit basis. Such information may be pragmatic in determining the flow of populace into a particular entrance, providing the venue with data which could be used to appropriately allocate scanning units in future events.

Upon successfully entering the scanning unit information 312, the user has the option of either manually entering the mobile scanning unit's identification number 315, such as a Unique Device Identifier (UDID) or International Mobile Equipment Identity (IMEI), or alternatively generate a QR® code 313 which the scanning unit can scan from another portable computing device with display capabilities.

If the ticket scanner desires to pursue registration by QR® code 313, the method for generating a QR® code described herein is similar to that which was described in process 100 whereby scanner information is encrypted into a scanner security string, appended to a URL, and inserted into a QR® code. The information encrypted into the scanner identification string could include, but is not limited to; scanner name, scanner description, device ID, event ID, and account ID. After the QR® code is generated in block 313, the scanner discerns the QR® registration barcode in block 314. The scanner does this by scanning another portable computing device's display output. Alternatively, the ticket scanner unit may read the barcode from an image file or bitmap stored inside its own memory, if it possesses the ability to do so. In either method, the contents of the QR® code are decrypted and the contained URL is subsequently visited.

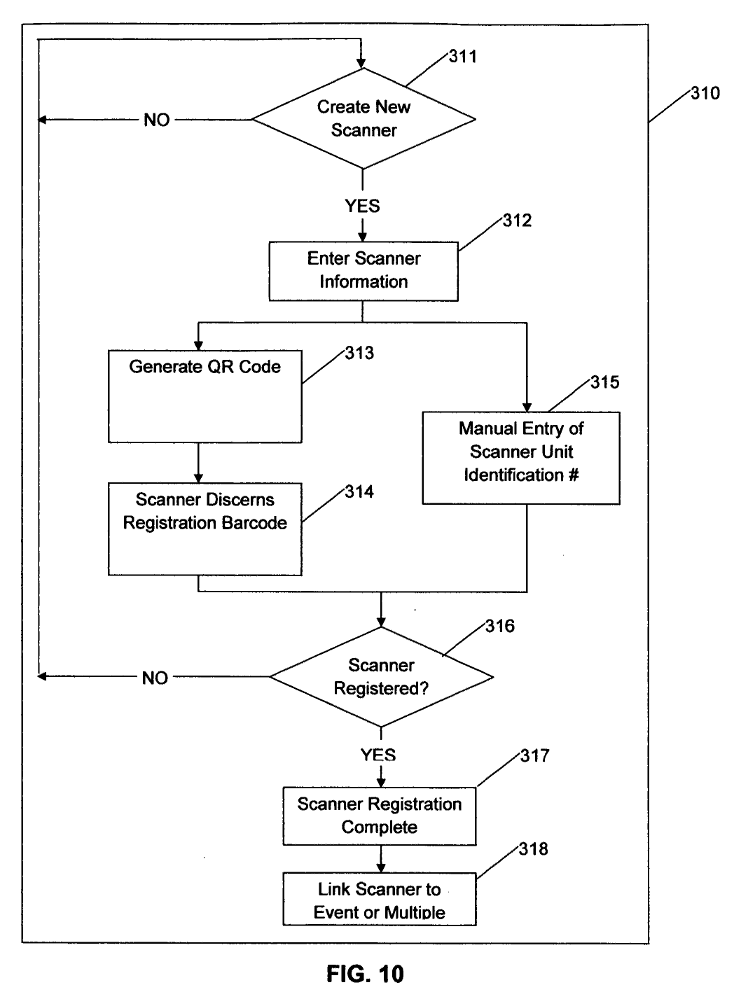

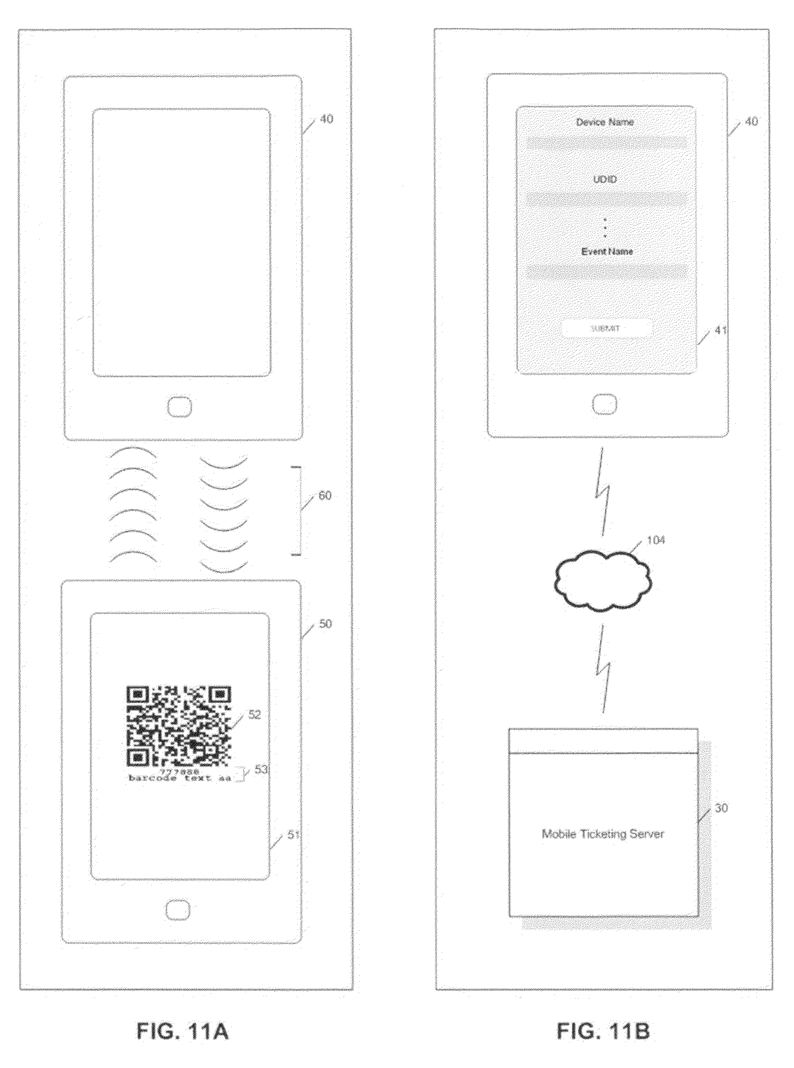

After successfully scanning the QR® code 314 or manually entering the scanning unit's identification number 315, the method moves onto decision block 316 whereby it determines if the device is authorized. In such block, the scanner identification string of the ticket scanning unit is verified against information registered with the mobile ticketing provider. Illustrations pertaining to this portion of the embodiment are labeled FIGS. 11A and 11B. If it is determined in block 316 that the new scanning unit is registered, the method moves to a block 317, whereby the user is notified of the completion of the scanner registration process.

From block 316, if it was determined that new scanning unit was not successfully registered, the method returns to a decision block 311, wherein the mobile ticketing transaction database determines if a registration request has been received from a ticket scanner or from venue management personnel, repeating the process. If scanner registration has been completed by a vendor, the method continues to a block 318, whereby the merchant is given the option to link the scanning unit to a specific event or multiple events.

FIGS. 11A and 11B elucidate two possible methods of registering a ticket scanning unit. FIG. 11A exhibits an embodiment of the invention that permits a ticket scanning unit 40 to automatically register itself through optical communication 60 with a mobile device 50. The mobile device displays a 2D scanner registration barcode 52 for a scanning unit registration ticket 53. The registration barcode may be sent to the mobile device's inbox by email, SMS/WAP-Push, or MMS message. Alternatively, as previously mentioned in FIG. 10, if the ticket scanning unit 40 has the ability to read barcodes from image files or bitmaps held inside its own memory, it may do so without ever having to optically communicate 60 with a mobile device 50. FIG. 11B displays an embodiment of the invention that warrants a ticket scanning unit 40 to manually register itself through communication with the mobile ticketing server 30 across an information network 104. A form is displayed on the screen 41 of the ticket scanning unit, whereby information such as the device name, UDID, and event name is entered into their corresponding text boxes. The information entered into the form, when submitted, is verified against previously registered scanning unit data in the mobile ticketing server. The principal benefit of manual registration by authorized personnel is enhanced security through avoiding possible methods of counterfeiting of accredited mobile ticket redemption units.

FIG. 12 illustrates an example of a process involving the redemption of a mobile ticket. As illustrated in this figure, a software algorithm decodes the QR® barcode into a URL, which is subsequently verified and utilized such that the mobile ticketing database is updated indicating redemption of the mobile ticket.

In the first step of this example, the mobile ticket scanning unit reads and attempts to decipher the QR® code and transaction type from the users' mobile device. If successful, the barcode reading software decodes the scanned image into the mobile ticket's previously-encoded URL and appends the scanning unit's device identification string to said URL.

In a decision block 341, the URL 331 obtained from the decoding process is verified against the mobile ticketing database 31. If the URL is deemed valid, the process continues to decision block 342. From block 341 if it is determined that the URL is not valid, the method informs the scanner and user of the invalidity of the mobile ticket and subsequently returns to block 321 to repeat the process.

In decision block 342, the verification process continues as the date and time upon which the user seeks to redeem their mobile ticket is compared against the date and time range within redemption is permitted. If it is determined in block 342 that the date and time of redemption is within the specified limits, the method moves to a block 371 whereby the mobile ticketing database is updated signifying the mobile ticket has, been redeemed and the user is allowed entry into the event. Furthermore, in this step notice is optionally provided to the 3rd party ticket vendor, if necessary, indicating the ticket has been discharged.

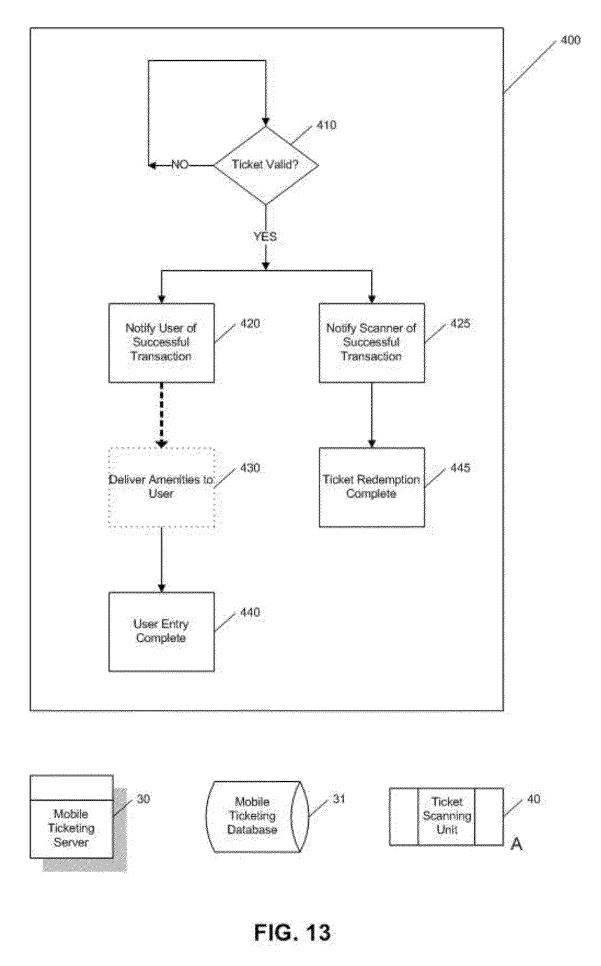

In another embodiment, as illustrated in FIG. 13, the present invention provides a method for acceptance of a mobile ticket 400. In a decision block 410, the ticket scanning unit 40, in communication with the mobile ticket vending server 30, determines whether new transaction data has been received. If it is determined in block 410 that the mobile ticket is valid, the method moves to a block 420 and a block 425 simultaneously, whereby the user and the ticket scanning unit are notified of the success of the transaction accordingly.

From block 410 if it was determined that new transaction data had not been received, the method returns to block 410, informs the scanning unit of a failed transaction, and repeats the process. The successful transaction messages, to the user 420, and the scanner 425, are customizable based upon the particular ticket application. For example, the success message may be different for a trade show, music event, or sporting event. In one embodiment, the method of creating a customized transaction message may be accomplished through use of the mobile ticketing database 31. However, any other module, such as the ticket scanning unit, may initiate the creation of such a message.

After the scanner has been notified of a successful transaction 425, the method continues onto block 445, whereby the process of redeeming the mobile ticket by the ticket scanning unit is complete. If the mobile ticket vendor chooses to distribute amenities and the user opts to accept the deliverance of amenities, the method proceeds from block 420 to 430. In block 430 the user is provided with amenities such as discount coupons and advertisements. Upon the successful transmission of the amenities to the user 430, the method continues to block 440, where the user's portion of the mobile ticketing acceptance process is complete. If the user chooses not to receive amenities or the mobile ticket vendor decides not to send amenities to the user 430, the method jumps from block 420 to block 440, whereby user entry is complete.

The foregoing description details certain embodiments of the invention. It will be understood, however, that no matter how detailed the aforementioned appears in text, the invention can be practiced in many, ways. As is also articulated heretofore, it should be noted that the use of particular terminology when describing certain attributes or aspects of the invention should not be taken to imply that the nomenclature is being re-defined herein to be restricted to including any specific characteristics of the features or perspectives of the invention with which that terminology is associated. The scope of the invention should therefore be construed in accordance with the appended claims and any equivalents thereof.

We claim:

1. A system for electronic ticket distribution, and redemption, as a Uniform Resource Locator (URL), comprised of the steps:
a) fabrication of an electronic ticket subsequent to purchase of such entity from a mobile device or personal computer;
b) encryption of the mobile ticket; download of the electronic ticket to a mobile device having a display output, where the mobile device is selected from the group consisting of, but not limited to, a personal digital assistant, a cell phone, an electronic organizer, and a multimedia music player;
c) authenticating a ticket scanning unit by a unique identity system;
d) accepting the electronic ticket by optical communication between the display output of the portable device and a authenticated ticket scanning unit;
e) providing appropriate amenities to a ticket user based on the accepted ticket.

2. The method of claim 1, wherein the host of the said URL is a ticket-redemption system or alternatively is comprised of the ability to communicate with a third-party ticket-redemption system.

3. The method of claim 1, wherein the step of encryption of mobile ticket is further comprised of generating a mobile ticket security string and a ticket identification string, of any length, that is known and authenticated by the mobile ticket provider.

4. The method of claim 3, further comprised of merging a unique ticket identification string, event identification string, user phone number, and user email address, in any combination, or any other identification string which is known to the ticket creator, only, in a pre-determined order and encrypting said combination or identification string it into a mobile ticket security string.

5. The method of claim 3, further comprised of generating a ticket identification string consisting of, but not limited to, the ticket, event, phone identification numbers or any combination thereof.

6. The method of claim 3, further comprising incorporating the event identification and mobile ticket security string into said URL.

7. The method of claim 1, wherein the step of authenticating a ticket scanning unit further comprises matching an identification string of any length that is unique to the ticket scanning unit with an identification string registered with the mobile ticketing provider.

8. The method of claim 7, further comprised of registering the ticket scanning unit's identification string with the mobile ticketing provider prior to an event in order that it may be recognized during mobile ticket redemption for that event.

9. The method of claim 8, wherein the step of registering the ticket scanning unit is comprised of manually entering the ticket scanning unit's unique identification number into the mobile ticketing scanner unit database for said event.

10. The method of claim 8, further comprised of calling a device activation URL with the scanning unit's identification string.

11. The method of claim 10, further comprising of automatically formulating a 2D barcode from the device activation URL.

12. The method of claim 11, wherein the step of automatically registering a ticket scanning unit comprises the step of optically scanning a 2D barcode displayed on a device having a display output selected from the group consisting of, but not limited to, a personal computer, a laptop computer, a personal digital assistant, a cell phone, an electronic organizer, and a multimedia music player, upon which the ticket scanning unit identification string is appended and registered with the URL devised in claim 10.

13. The method of claim 1, wherein the step of accepting the electronic ticket further comprises reading the mobile ticket bar code from the user's mobile communications device with a ticket scanning unit; and determining whether to permit entry to the ticketed event.

14. The method of claim 13, further comprised of the ticket scanning unit decoding the mobile ticket barcode object into a URL and appending the scanning unit's device identification string to the URL.

15. The method of claim 13, further comprised of the ticket scanning unit accessing the host server of the mobile ticket's URL though an Internet connection.

16. The method of claim 15, further comprised of accessing the host server of the mobile ticket's URL through a data call or browser session.

17. The method of claim 13, further comprising the ticket provider authenticating the URL string by verifying the device identification string of the ticket scanning unit and ticket information string.

18. The method of claim 17, further comprised of re-creating the mobile ticket security string using data from the ticket information string and data only known by the ticketing provider.

19. The method of claim 18, further comprising correlation of the re-encrypted security data string to the security string in the URL.

20. The method of claim 13, further comprised of receiving an indication that the ticket information has been scanned by a bar code scanner and communicating customized response messages to the ticket scanning unit and to the user's mobile device.
